(19) United States
(12) Patent Application Publication
(10) Pub. No.: US 2026/0261726 A1
(43) Pub. Date: Sep. 3, 2026

(54) TV AND TV CONTROL METHOD

(71) Applicant: LG ELECTRONICS INC., Seoul (KR)

(72) Inventor: Seungwook KIM, Seoul (KR)

(73) Assignee: LG ELECTRONICS INC., Seoul (KR)

(21) Appl. No.: 18/994,501

(22) PCT Filed: Jul. 18, 2022
(86) PCT No.: PCT/KR2022/010424

§ 371 Date: Jan. 14, 2025

(51) Int. Cl. H04N 21/41; H04N 21/433; H04N 21/436; H04N 21/4363

(52) U.S. Cl. CPC H04N 21/41265; H04N 21/4332; H04N 21/43615; H04N 21/43637

(57) ABSTRACT

Provided in an embodiment of the present disclosure is a TV comprising: a network interface unit that receives data from at least one smartphone; a display that outputs content; a storage unit that stores data received from the at least one smartphone; and a control unit that controls the network interface unit, the display, and the control unit, wherein the control unit connects communication with the at least one smartphone and receives backup data on the basis of a backup setting from the at least one smartphone.

### TECHNICAL FIELD

The present disclosure relates to a TV and a method for controlling the TV.

### BACKGROUND

With the increasing development of information society, the demand for display devices is also increasing in various forms. In response to this trend, various display devices, for example, Liquid Crystal Display (LCD), Field Emission Display (FED), Plasma Display Panel (PDP), an electroluminescent device, etc. have recently been developed.

A liquid crystal panel of the LCD may include a liquid crystal layer, may further include a thin film transistor (TFT) substrate and a color filter substrate that are arranged to face each other on the basis of the liquid crystal panel interposed therebetween, and may display an image using light provided from a backlight unit.

As an example of an electroluminescent device, active-matrix-type organic light emitting display (OLED) devices are commercially available on the market and widely used throughout the world. Since the OLED device is a self-emitting device, the OLED device has no backlight and is advantageous in terms of a response speed and a viewing angle as compared to the LCD, so that the OLED devices are attracting attention as next-generation displays.

Prior art patent application publication No. 10-2009-0113609 (hereinafter, referred to as Prior Patent 1) discloses a method for synchronizing data between a mobile terminal and a TV. In particular, Prior Patent 1 proposes a method for automatically backing up the data between the mobile terminal and the TV, thereby eliminating a need for a USB cable or the like and solving problems caused by limited capacity of the mobile terminal.

However, Prior Patent 1 simply proposes one-to-one data exchange between one mobile terminal and the TV, and does not propose a specific embodiment for backing up data from a plurality of mobile terminals.

### SUMMARY

### Technical Problem

The present disclosure aims to provide a TV and a method for controlling the TV to solve the above problem.

### Technical Solutions

An embodiment of the present disclosure provides a TV including a network interface that receives data from at least one smartphone, a display that outputs content, storage that stores the data received from the at least one smartphone, and a controller that controls the network interface, the display, and the controller, wherein the controller establishes communication with the at least one smartphone, and receives backup data from the at least one smartphone based on backup settings.

The backup settings may include whether to store, a storage start setting, and a storage timing setting.

The controller may classify the received backup data into directory structures based on an owner, a date, and a category of the backup data, and output the classified directory structures via the display.

The controller may output a backup data list of a first smartphone, and when receiving a request for sharing first backup data included in the list to a second smartphone, transmit the first backup data to the second smartphone.

The controller may output a group settings screen, receive a selection corresponding to at least some files of the received backup data included in the group settings screen, and create a group composed of the at least one file based on the selection.

The controller may receive an event including a date from a user, and output the at least some files included in the crated group based on the date of the event via the display.

The controller may output the at least some files in at least one of following situations: at a first time, during power-on of the TV, during power-off of the TV, and during channel switching.

The controller may receive account information from a user, and output a health service screen via the display based on the account information and health data received from a smartphone of the user.

The controller may allocate backup capacity to the at least one smartphone, wherein the allocated backup capacity is determined based on a capacity policy selected by a user.

The controller may identify that a user of a third smartphone and a user of a fourth smartphone are watching the TV, transmit backup data received from the third smartphone to the fourth smartphone, and transmit backup data received from the fourth smartphone to the third smartphone.

The controller may receive the backup data in at least one of following situations: at a second time, during power-on of the TV, during power-off of the TV, during execution of a first application, and during channel switching.

An embodiment of the present disclosure provides a method for controlling a TV including establishing communication with at least one smartphone, receiving backup data from the at least one smartphone based on backup settings, and storing the data received from the at least one smartphone.

### Advantageous Effects

According to an embodiment of the present disclosure, it is available to avoid using the paid cloud service via the mobile carrier.

In addition, according to an embodiment of the present disclosure, by filtering the duplicate data from the user data of the smartphones owned by the family members, the storage space and the backup time may be saved, and the cost and the time for the data backup for all of the smartphones of the family members may be reduced.

Effects that may be obtained from the present disclosure are not limited to the effects mentioned above, and other effects not mentioned are able to be clearly understood by those skilled in the art in the technical field to which the present disclosure belongs from a description below.

### BRIEF DESCRIPTION OF THE DRAWINGS

FIG. 1 is a block diagram illustrating constituent elements of a TV according to an embodiment of the present disclosure.

FIG. 2 is a view illustrating constituent modules of a TV according to an embodiment of the present disclosure.

FIG. 3 is a view illustrating a data backup settings embodiment of a TV and a smartphone according to an embodiment of the present disclosure.

FIG. 4 is a view illustrating an embodiment of organizing data stored in a TV according to an embodiment of the present disclosure into directories.

FIG. 5 is a view illustrating an embodiment of sharing data stored in a TV according to an embodiment of the present disclosure.

FIG. 6 is a view illustrating an embodiment of managing data stored in a TV according to an embodiment of the present disclosure.

FIG. 7 is a view illustrating a notification service of a TV according to an embodiment of the present disclosure.

FIG. 8 is a view illustrating a health service of a TV according to an embodiment of the present disclosure.

FIG. 9 is a view illustrating a capacity management policy of a TV according to an embodiment of the present disclosure.

FIG. 10 is a view illustrating an embodiment of exchanging data between users watching a TV according to an embodiment of the present disclosure.

FIG. 11 is a view illustrating a method for controlling a TV according to an embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

On the other hand, the TV described herein is, for example, an intelligent image display device implemented by adding a computer support function to a broadcast reception function, and further includes an Internet function or the like while sufficiently performing the broadcast reception function, so that the image display device may have user-friendly interfaces such as a handwriting input device, a touchscreen, or a spatial remote controller. Further, the image display device can support a wired or wireless Internet function by connecting to the Internet and a computer device, thereby performing e-mailing, web browsing, banking, or gaming. To implement these functions, the image display device may operate based on a standard general-purpose Operating System (OS).

Accordingly, the TV according to the present disclosure is designed in a manner that various applications can be easily added to or deleted from a general-purpose OS kernel so that the image display device can perform various user-friendly functions. The image display device may be, for example, a network TV, a Hybrid broadcast broadband TV (HBBTV), a smart TV, etc. The TV is applicable to a smartphone as needed.

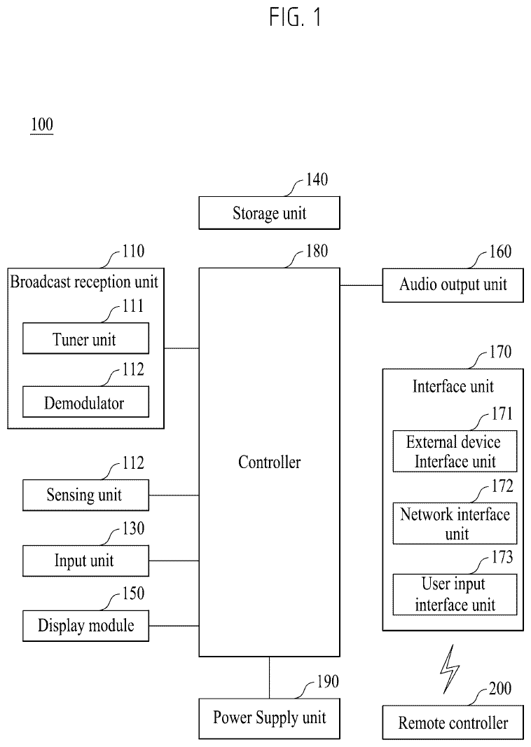

FIG. 1 is a block diagram illustrating constituent elements of a TV 100 according to an embodiment of the present disclosure.

Referring to FIG. 1, the TV 100 may include a broadcast reception unit 110, an external device interface unit 171, a network interface unit 172, a storage unit 140, a user input interface unit 173, an input unit 130, a controller 180, a display 150, an audio output unit 160, and/or a power-supply unit 190.

The broadcast reception unit 110 may include a tuner unit 111 and a demodulator 112.

Although not shown in the drawings, the TV 100 may include only the external device interface unit 171 and the network interface unit 172 from among the broadcast reception unit 110, the external device interface unit 171, and the network interface unit 172. That is, the TV 100 may not include the broadcast reception unit 110.

The tuner unit 111 may select a broadcast signal corresponding to either a user-selected channel or all prestored channels from among broadcast signals received through an antenna (not shown) or a cable (not shown). The tuner unit 111 may convert the selected broadcast signal into an intermediate frequency (IF) signal or a baseband image or a voice signal.

For example, when the selected broadcast signal is a digital broadcast signal, the tuner unit 111 may convert the selected broadcast signal into a digital IF (DIF) signal. When the selected broadcast signal is an analog broadcast signal, the tuner unit 111 may convert the selected broadcast signal into an analog baseband image or a voice signal (CVBS/SIF). That is, the tuner unit 111 may process the digital broadcast signal or the analog broadcast signal. The analog baseband image or the voice signal (CVBS/SIF) output from the tuner unit 111 may be directly input to the controller 180.

The tuner unit 111 may sequentially select broadcasting signals of all broadcasting channels stored through a channel memory function from among the received broadcast signals, and may convert the selected broadcast signal into an intermediate frequency (IF) signal or a baseband image or a voice signal.

The tuner unit 111 may include a plurality of tuners to receive broadcast signals of the plurality of channels. Alternatively, a single tuner for simultaneously receiving broadcast signals of the plurality of channels is also possible.

The demodulator 112 may receive the digital IF signal (DIF) converted by the tuner unit 111, and may thus perform demodulation of the received signal. The demodulator 112 may perform demodulation and channel decoding, and may output a stream signal (TS). The stream signal may be a signal formed by multiplexing an image signal, a voice signal, or a data signal.

The stream signal (TS) output from the demodulator 112 may be input tio the controller 180. The controller 180 may perform demultiplexing, image/audio signal processing, etc., may output an image through the display 150, and may output a voice through the audio output unit 160.

The sensing unit 120 may sense a change in the TV 100 or may sense an external change. For example, the sensing unit 120 may include a proximity sensor, an illumination sensor, a touch sensor, an infrared (IR) sensor, an ultrasonic sensor, an optical sensor (e.g., a camera), a voice sensor (e.g., a microphone), a battery gauge, environmental sensors (e.g., hygrometer, a thermometer, etc.).

The controller 180 may check a state of the TV 100 based on information collected by the sensing unit 120, may notify the user of a problem, or may control the TV 100 to be kept in the best state.

In addition, it is possible to provide an optimal viewing environment by differently controlling the content, image quality, size, etc. of the image provided to the display module 180 depending on the viewer, ambient illuminance, etc. sensed by the sensing unit. As the smart TV has evolved, the number of functions mounted in the display device increases, and the number of the sensing units 20 also increases together with the increasing functions.

The input unit 130 may be provided at one side of a main body of the TV 100. For example, the input unit 130 may include a touch pad, a physical button, and the like. The input unit 130 may receive various user commands related to the operation of the TV 100, and may transmit a control signal corresponding to the input command to the controller 180.

Recently, as a bezel of the TV 100 decreases in size, the number of display devices 100 each including a minimum number of input unit 130 formed in a physical button exposed to the outside is rapidly increasing. Instead, a minimum number of physical buttons may be provided on the back or side surface of the TV 100. The display device may receive a user input through the remote controller 200 through a touchpad or a user input interface unit 173 to be described later.

The storage unit 140 may store a program for processing and controlling each signal used in the controller 180, and may store a signal-processed image, a voice, or a data signal. For example, the storage unit 140 may store application programs designed for the purpose of performing various tasks that can be processed by the controller 180, and may selectively provide some of the stored application programs upon request of the controller 180.

The program stored in the storage unit 140 is not specifically limited to being executed by the controller 180. The storage unit 140 may perform a function for temporarily storing an image, a voice, or a data signal received from an external device through the external device interface unit 171. The storage unit 140 may store information about a predetermined broadcast channel through a channel memory function such as a channel map.

Although the storage unit 140 of FIG. 1 is provided separately from the controller 180, the scope of the present disclosure is not limited thereto, and the storage unit 140 may also be included in the controller 180 as needed.

The storage unit 140 may include at least one of a volatile memory (e.g., DRAM, SRAM, SDRAM, etc.) and a non-volatile memory (e.g., flash memory, hard disk drive (HDD), solid state drive (SSD), etc.).

The display 150 may generate a drive signal by converting an image signal, a data signal, an OSD signal, a control signal processed by the controller 180, or by converting an image signal, a data signal, a control signal, etc. received from the interface unit 171. The display 150 may include a display panel 181 having a plurality of pixels.

A plurality of pixels included in the display panel may include RGB sub-pixels. Alternatively, a plurality of pixels included in the display panel may include sub-pixels of RGBW. The display 150 may convert the image signal, the data signal, the OSD signal, the control signal, etc. processed by the controller 180 to generate a drive signal for the plurality of pixels.

The display 150 may be implemented as a plasma display panel (PDP), a liquid crystal display (LCD), an organic light emitting diode (OLED), a flexible display, etc. In addition, the display 150 may also be implemented as a three-dimensional (3D) display. The three-dimensional (3D) display 150 may be classified into a glassless-type 3D display and a glasses-type 3D display.

The display device may include a display module that occupies most parts of the front surface, and a case that covers the back and side surfaces of the display module and packages the display module.

Recently, the TV 100 has evolved from a flat-screen display to a curved-screen display. In order to implement the curved screen, the TV 100 may use a display module 150 that can be bent or curved, such as a light emitting diode (LED) or an organic light emitting diode (OLED), etc.

Conventionally, the LCD has difficulty in self-emitting light, so that the conventional LCD has been designed to receive light through a backlight unit. The backlight unit is a device for uniformly supplying light received from a light source to a liquid crystal located on the front surface of the display device. As the backlight becomes thinner, a thin LCD can be implemented. However, it is actually difficult for the backlight unit to be implemented as a curved structure formed of a flexible material. Although the backlight unit is implemented as a curved shape, it is difficult for light to be uniformly applied to the liquid crystal, thereby changing brightness of the screen.

On the other hand, the LED or the OLED is designed in a manner that each of constituent elements constructing the pixels can self-emit light without using the backlight unit, so that the LED or the OLED can be implemented as a curved shape without any problems. In addition, since each element can perform self-emission of light, brightness of each element is not affected by a change in the positional relationship between the element and adjacent elements, so that a curved display module 150 can be implemented as an LED or OLED.

OLED (Organic Light Emitting Diode) panels appeared in earnest in mid-2010 and are rapidly replacing LCDs in the small-and medium-sized display market. The OLED is a display made using the self-emission characteristics in which OLED emits light when a current flows in a fluorescent organic compound. Since the response speed of the OLED is faster than that of the LCD, there is little afterimage when moving images are implemented.

OLEDs may be used as a light-emitting display product. In this case, the light-emitting display device may use three fluorescent organic compounds (such as red, green, and blue) each having a self-emitting function, and may use the self-emitting phenomenon in which positive(+)-charged particles and electrons injected from a cathode and anode are combined with each other within the organic material, so that a backlight unit causing degradation of color sense need not be used.

The LED panel is implemented by technology for using only one LED element as one pixel, and has a smaller LED element compared to the prior art, so that a curved display module 150 can be implemented. Whereas the conventional device referred to as an LED TV can use the LED as a light source of the backlight unit for supplying light to the LCD, it is impossible for the LED of the conventional device to constitute a screen.

The display module may include a display panel, a coupling magnet located on the rear surface of the display panel, a first power-supply unit, and a first signal module. The display panel may include a plurality of pixels (R, G, B). The plurality of pixels (R, G, B) may be formed in each region where a plurality of data lines and a plurality of gate lines cross each other. The plurality of pixels (R, G, B) may be arranged in a matrix.

For example, the plurality of pixels (R, G, B) may include a red(R) sub-pixel, a green(G) sub-pixel, and a blue(B) sub-pixel. The plurality of pixels (R, G, B) may further include white (W) sub-pixel(s).

In the display module 150, one side where an image is displayed may be referred to as a front side or a front surface. When the display module 150 displays an image, one side where no image is observed may be referred to as a rear side or a rear surface.

Meanwhile, the display 150 may be implemented as a touchscreen, so that the display 150 can also be used as an input device in addition to an output device.

The audio output unit 160 may receive a voice-processed signal from the controller 180, and may output the received signal as a voice signal.

The interface unit 170 may serve as a path of connection to various kinds of external devices connected to the TV 100. The interface unit may include not only a wired method for transmitting/receiving data through a cable, but also a wireless method using the antenna.

The interface unit 170 may include at least one of a wired/wireless headset port, an external charger port, a wired/wireless data port, a memory card port, a port connected to a device having an identification module, an audio input/output (I/O) port, a video I/O port, and an earphone port.

As an example of a wireless method, the above-described broadcast reception unit 110 may be used. The broadcast reception unit 110 may be configured to use a broadcast signal, a mobile communication short-range communication signal, a wireless Internet signal, and the like.

The external device interface unit 171 may transmit or receive data to and from a connected external device. To this end, the external device interface unit 171 may include an A/V input/output (I/O) unit (not shown).

The external device interface unit 171 may be wired or wirelessly connected to an external device such as a digital versatile disc (DVD) player, a Blu-ray player, a game console, a camera, a camcorder, a computer (laptop), a set-top box, or the like, and may perform an input/output (I/O) operation with the external device.

In addition, the external device interface unit 171 may establish a communication network with various remote controllers 200, may receive a control signal related to operation of the TV 100 from the remote controller 200, or may transmit data related to operation of the TV 100 to the remote controller 200.

The external device interface unit 171 may include a wireless communication unit (not shown) for short-range wireless communication with other electronic devices. Through the wireless communication unit (not shown), the external device interface unit 171 may exchange data with an adjacent mobile terminal. In particular, the external device interface unit 171 may receive device information, application information, an application image, and the like from the mobile terminal in a mirroring mode.

The network interface unit 172 may provide an interface for connecting the TV 100 to a wired/wireless network including the Internet network. For example, the network interface unit 172 may receive content or data provided by the Internet, a content provider, or a network administrator through a network. The network interface unit 172 may include a communication module (not shown) for connection with the wired/wireless network.

The external device interface unit 171 and/or the network interface unit 172 may include a communication module for short-range communication such as Wi-Fi, Bluetooth, Bluetooth low energy (BLE), ZigBee, Near Field Communication (NFC), and a communication module for cellular communication such as Long-Term Evolution (LTE), LTE-A (LTE Advanced), Code Division Multiple Access (CDMA), WCDMA(wideband CDMA), UMTS(universal mobile telecommunications system), WiBro(Wireless Broadband), etc.

The user input interface unit 173 may transmit user input signals to the controller 180, or may transmit signals received from the controller 180 to the user. For example, the user input interface unit 173 may transmit or receive user input signals (such as a power-on/off signal, a channel selection signal, and a screen setting signal) to and from the remote controller 200, may transmit user input signals received through a local key (not shown) such as a power key, a channel key, a volume key, and a setting key to the controller 180, may transmit a user input signal received by a sensor unit (not shown) for sensing a user gesture to the controller 180, or may transmit a signal received from the controller 180 to the sensor unit.

The controller 180 may include at least one processor, and may control the overall operation of the TV 100 using the processor included therein. Here, the processor may be a general processor such as a CPU. Of course, the processor may be a dedicated device such as an ASIC, or other hardware-based processor.

The controller 180 may demultiplex the stream received through the tuner unit 111, the demodulator 112, the external device interface unit 171, or the network interface 172, and may process the demultiplexed signals to generate and output a signal for image or voice output.

The image signal processed by the controller 180 may be input to the display 150 and displayed as an image corresponding to the corresponding image signal. In addition, the image signal processed by the controller 180 may be input to the external output device through the external device interface unit 171.

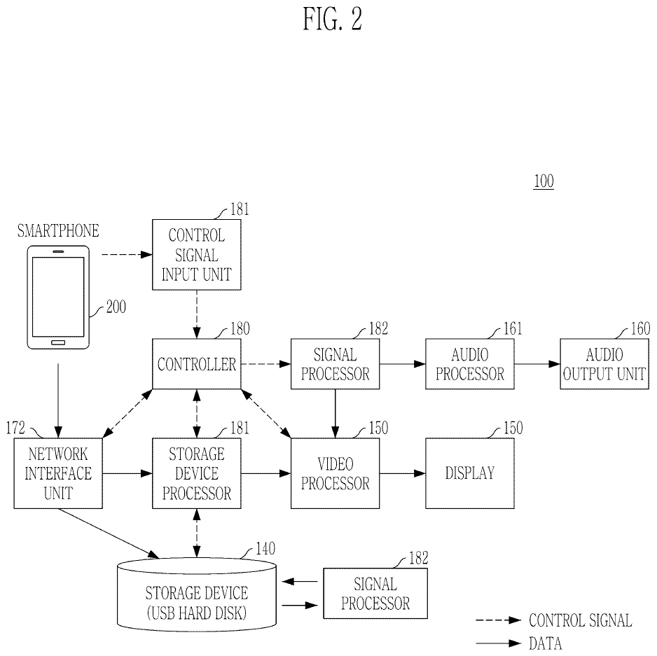

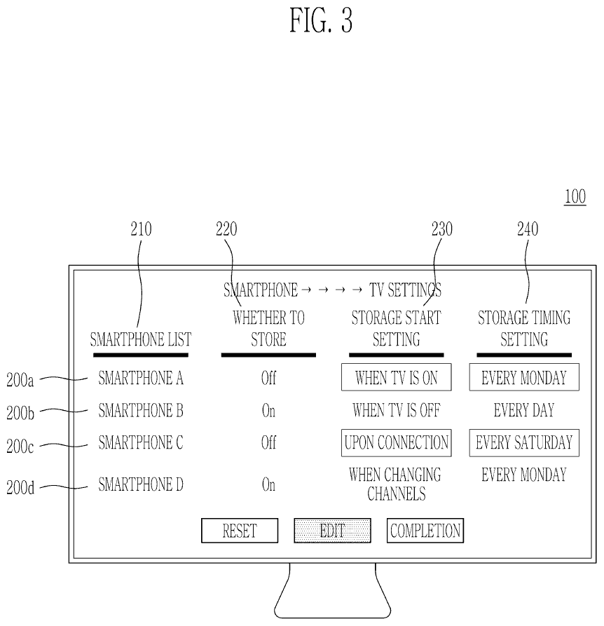

The voice (or audio) signal processed by the controller 180 may be audibly output to the audio output unit 160. In addition, the voice signal processed by the controller 180 may be input to the external output device through the external device interface unit 171. Although not shown in FIG. 2, the controller 180 may include a demultiplexer, an image processor, and the like, and a detailed description thereof will hereinafter be described with reference to FIG. 3.

In addition, the controller 180 may control the overall operation of the TV 100. For example, the controller 180 may control the tuner unit 111 to select a broadcast program corresponding to either a user-selected channel or a prestored channel.

In addition, the controller 180 may control the TV 100 by a user command or an internal program received through the user input interface unit 173. The controller 180 may control the display 150 to display an image. In this case, the image displayed on the display 150 may be a still image or a moving image, and may be a 2D image or a 3D image.

On the other hand, the controller 180 may display a predetermined 2D object in the image displayed on the display 150. For example, the object may be at least one of a connected web screen (newspaper, magazine, etc.), electronic program guide (EPG), various menus, widgets, icons, still images, moving images, and text.

Meanwhile, the controller 180 may modulate and/or demodulate the signal using an amplitude shift keying (ASK) scheme. Here, the ASK scheme may refer to a method for modulating a signal by differentiating the amplitude of a carrier wave according to data values or for restoring an analog signal to a digital data value according to the amplitude of the carrier wave.

For example, the controller 180 may modulate an image signal using the ASK scheme, and may transmit the modulated signal through a wireless communication module.

For example, the controller 180 may demodulate and process the image signal received through the wireless communication module using the ASK scheme.

Accordingly, the TV 100 may simply transmit and receive signals to and from other image display devices arranged adjacent to each other without using either a unique identifier such as a Media Access Control (MAC) address or a complex communication protocol such as TCP/IP.

On the other hand, the TV 100 may further include a photographing unit (not shown). The photographing unit may photograph a user. The photographing unit may be implemented as one camera, but is not limited thereto, and may be implemented by a plurality of cameras. On the other hand, the photographing unit may be embedded in the TV 100 or may be separately arranged on the display 150. The image information photographed by the photographing unit may be input to the controller 180.

The controller 180 may recognize the position of the user based on the image photographed by the photographing unit. For example, the controller 180 may recognize a distance (z-axis coordinates) between the user and the TV 100. In addition, the controller 180 may recognize the X-axis coordinate and the Y-axis coordinate within the display 150 corresponding to the user position.

The controller 180 may sense a user gesture based on an image photographed by the photographing unit, each of signals detected by the sensor unit, or a combination thereof.

The power-supply unit 190 may supply corresponding power to the TV 100. In particular, the controller 180 may be implemented as a System on Chip (SoC), a display 150 for displaying an image, and an audio output unit 160 for audio output.

Specifically, the power-supply unit 190 may include a converter (not shown) for converting AC power into DC power, and a DC/DC converter (not shown) for converting the level of DC power.

On the other hand, the power-supply unit 190 may receive power from the external power source, and may distribute the received power to the respective components. The power-supply unit 190 may be directly connected to the external power source to supply AC power, and may include a battery capable of being charged with electricity.

In the former case, the power-supply unit 190 may be used by connecting to a wired cable, and it is difficult for the power-supply unit 190 to move from one place to another place, and the movement range of the power-supply unit 190 is limited. In the latter case, the power-supply unit 190 can move from one place to another place, but the weight and volume of the power-supply unit 190 may increase as much as the weight and volume of the battery. In addition, for charging, the power-supply unit 190 should be directly connected to a power cable for a predetermined period of time or should be coupled to a charging cradle (not shown) for power supply.

The charging cradle may be connected to the display device through a terminal exposed to the outside. Alternatively, if the power-supply unit 190 approaches the charging cradle using a wireless interface, a built-in battery of the power-supply unit 190 may also be charged with electricity.

The remote controller 200 may transmit a user input to the user input interface unit 173. To this end, the remote controller 200 may use Bluetooth, Radio Frequency (RF) communication, infrared (IR) communication, Ultra-Wideband (UWB), ZigBee, or the like. In addition, the remote controller 200 may receive the image, voice, or data signal output from the user input interface unit 173, and may display or audibly output the received image, voice, or data signal.

On the other hand, the above-described TV 100 may be a fixed or mobile digital broadcast receiver capable of receiving digital broadcast signals.

Meanwhile, the block diagram of the TV 100 shown in FIG. 1 is disclosed for only for illustrative purposes for one embodiment of the present disclosure, and the respective components of the TV 100 shown in FIG. 1 can be integrated, added or omitted according to the specifications of the digital device 100 which is actually implemented.

That is, if necessary, two or more components may be combined into one component, or one component may be subdivided into two or more components. In addition, the functions performed in each block are intended to explain the embodiment of the present disclosure, and the specific operation or device does not limit the scope of the present disclosure.

Previously, videos, photos, music files, and the like stored on individual smartphones had to be automatically backed up to a cloud server of a mobile carrier (U+, SKB, KT, and the like) periodically or had to be connected to a PC or the like and then manually backed up by a user of the smartphone.

First, when using the mobile carrier, a fee for using a cloud service of the mobile carrier may incur, and this may cause inconvenience caused by service changes depending on circumstances of the mobile carrier. In particular, recently, as the mobile carrier has started using other cloud services, mandatory additional charges have been incurred. In addition, there is a restriction that the mobile carrier should be visited when there is a need to re-download or use the backed-up data from the mobile carrier.

In addition, reminder services provided by the mobile carriers or the paid cloud servers are mostly limited to simple reminder services based on temporal concepts, such as 1 year ago, 10 years ago, and today.

In addition, for the manual backup, the user needs to connect a cable and perform the backup at a visually and spatially convenient time, and a separate manual backup should be performed for each family member's smartphone. Similarly, when one user uses multiple smartphones, it is inconvenient to share and manage data from each smartphone.

In addition, in the case of smartphone data, files are shared between the family members mainly via a social media service such as KakaoTalk, but it is inconvenient to share large video files or many files at once, and it is not easy to manage the shared data.

In addition, when the user performs the manual backup, there is no reminder service (memory notification or other management service) for the backed up data after the backup, so that the data is frequently overlooked or left unmanaged and lost.

Therefore, an embodiment of the present disclosure is proposed to solve the above-mentioned problems. In addition, an embodiment of the present disclosure aims to automatically back up health-related data (blood pressure/sleep status/body composition measurement/diabetes level/body temperature, and the like) linked to a smart watch to the cloud server, and to address the lack of specialized tracking and reminder-linked services.

To this end, it is to provide a backup service via a communication protocol such as Bluetooth, TCP/IP, and the like provided by the TV, in which the user data (the photos, the videos, the music files, other files, and the like) of the smartphone is automatically backed up via a cloud of the mobile carrier or an OS platform company such as Google or Apple, or the user is enabled to periodically connect to a personal PC to back up the data.

More specifically, the smartphone data of the users using the TV is stored and registered on a USB HDD connected to the TV, making the data sharing and management between the smartphone users more convenient. In addition, it is to provide a platform and a service that may provide relaxation and satisfaction to the user by playing the corresponding data or providing the notification service or the like in conjunction with an Always on service provided by the TV or other TV services.

Accordingly, when an embodiment of the present disclosure is used, there is an advantage in that it is available to avoid using the paid cloud service via the mobile carrier.

In addition, after setting up the TV and a virtual cloud service, using the USB HDD connected to the TV, the user data of the smartphone may be automatically and periodically backed up to a storage device such as the USB HDD connected to the TV, similar to the cloud service via the mobile carrier, so that convenience in data management may be provided.

In addition, by filtering duplicate data from the user data of the smartphones owned by the family members, a storage space and a backup time may be saved, and a cost and a time for the data backup for all of the smartphones of the family members may be reduced.

The present disclosure will be described in detail below with reference to FIGS. 2 to 11.

FIG. 2 is a view illustrating constituent modules of a TV according to an embodiment of the present disclosure. Hereinafter, descriptions that are redundant with the above-described content will be omitted.

Referring to FIG. 2, the TV 100 according to an embodiment of the present disclosure may include the storage device 140, the display 150, the audio output unit 160, the network interface unit 172, and the controller 180 described above in FIG. 1. In addition, the TV 100 may further include a storage device processor 141, a video processor 151, an audio processor 161, a control signal input unit 181, and a signal processor 182, in addition to the constituent modules described above in FIG. 2.

The storage device 140 may include an internal hard disk (hereinafter, HDD) in the TV 100 or an HDD connected via the USB cable. In this regard, the storage unit 140 may store data received from the smartphone 200 via the network interface unit 172 and the storage device processor 181.

The display 150 may output content or the like of the provided video. In this regard, the display 150 may receive a control signal received from the smartphone 200 via the control signal input unit 181, the controller 180 may transmit the same to the signal processor 182, and the processed signal may be output as a video via the video processor 150.

The audio output unit 160 may output an audio signal or the like. In this regard, the audio output unit 160 may receive the control signal from the smartphone 200 via the control signal input unit 181, the controller 180 may transmit the same via the signal processor 182, and the processed signal may be output as a voice via the audio processor 161.

The network interface unit 172 may include a wired/wireless network for connecting the smartphone 200 with the TV 100. For example, the network interface unit 172 may include Wi-Fi, Bluetooth, NFC, and the like.

The controller 180 may generate and process the control signal transmitted and received between the control signal input unit 1810, the network interface unit 172, the signal processor 182, and the storage device processor 181. Hereinafter, various operations performed by the controller 180 will be described as being performed by the TV 100.

The storage device processor 141 may store the data received from the smartphone 200 in the storage device 140. The video processor 151 may process the control signal received from the smartphone 200 and output the processed signal via the display 150. The audio processor 161 may process the control signal received from the smartphone 200 and output the processed signal via the audio output unit 150.

The control signal input unit 181 may receive the control signal received from the smartphone 200 and transmit the same to the controller 180. The signal processor 182 may process the signal received from the controller 180 and transmit the same to each of the video processor 150 and the audio processor 161.

FIG. 3 is a view illustrating a data backup settings embodiment of a TV and a smartphone according to an embodiment of the present disclosure. Hereinafter, descriptions that are redundant with the above-described content will be omitted.

In an embodiment of the present disclosure, the TV 100 may receive backup data from at least one connected smartphone in at least one of the following situations: at a first time, during power-on of the TV 100, during power-off of the TV 100, during execution of a first application, and during channel switching.

Hereinafter, the embodiment in FIG. 3 assumes that the TV 100 is turned on, the user's smartphone is turned on, and the smartphone is identified by the TV. In an embodiment of the present disclosure, the TV 100 may be in communication with the at least one smartphone, and receive the backup data from the at least one connected smartphone based on backup settings.

Referring to FIG. 3, the TV 100 may receive the backup data from the at least one smartphone based on the backup settings. Here, the backup settings may include whether to store 220, a storage start setting 230, and a storage timing setting 240.

More specifically, the TV 100 may receive the backup data from the at least one smartphone in a background or a foreground based on the backup settings.

To this end, the TV 100 may output a list 210 of the at least one recognized smartphone 200a, 200b, 200c, and 200d when connected to the at least one smartphone.

Thereafter, the TV 100 may output current states of whether to store 220, the storage start setting 230, and the storage timing setting 240 for each of the at least one connected smartphone 200a, 200b, 200c, and 200d.

Referring to the example in FIG. 3, for a smartphone B 200b, whether to store 220 is set to “On”, the storage start setting 230 is set to “When TV is Off”, and the storage timing setting 240 is set to “Everyday”. In this case, the TV 100 may receive the backup data from the smartphone B 200b every day when the TV 100 is turned off, based on the backup settings of the smartphone B 200b.

Similarly, for a smartphone D 200d, whether to store 220 is set to “On”, the storage start setting 230 is set to “When channel is switched”, and the storage timing setting 240 is set to “Every Monday”. In this case, the TV 100 may receive the backup data from the smartphone D 200d every Monday when the channel of the TV 100 is switched, based on the backup settings of the smartphone D 200d. That is, because the TV 100 is often idle when switching the channel, it is a good situation to receive the backup data from the at least one smartphone 200a, 200b, 200c, and 200d.

The user may modify or initialize the smartphone list 210, whether to store 220, the storage start setting 230, and the storage timing setting 240 being output on the TV 100 by selecting them via a remote control device (not shown).

By setting whether the backup is available, an operation of the TV 100 that may start the backup, a start condition, and the like for each smartphone, excessive consumption of a performance and resources of the TV 100 may be prevented.

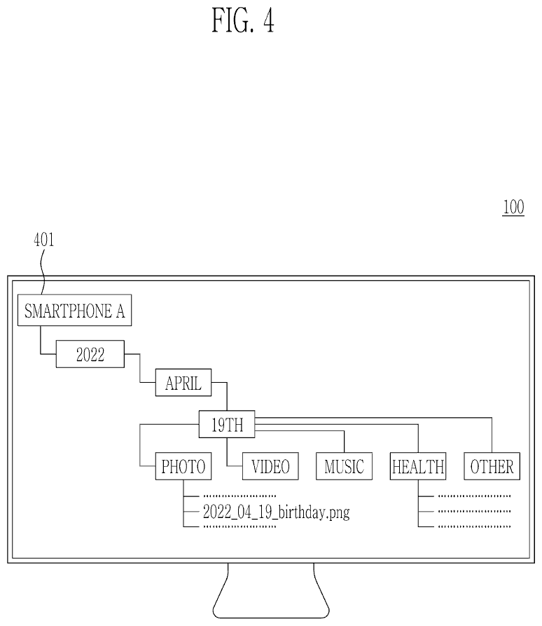

FIG. 4 is a view illustrating an embodiment of organizing data stored in a TV according to an embodiment of the present disclosure into directories. Hereinafter, descriptions that are redundant with the above-described content will be omitted.

In an embodiment of the present disclosure, the TV 100 may classify the backup data received with the embodiment in FIG. 3 into directory structures based on an owner, a date, and a type of the backup data, and output the classified directory structures via the display.

That is, it is to propose a method for storing and managing the backup data of the family members or the user who has the multiple smartphones.

That is, the TV 100 may classify the backup data into the directory structures based on the owner, a creation date, and a category of the backup data, via the embedded HDD or the external HDD.

Referring to FIG. 4, the TV 100 may output the backup data based on a smartphone 401 that owns the received backup data. Thereafter, the TV 100 may classify the backup data into the directory structures based on the creation date or an upload date of the backup data of the smartphone 401. Thereafter, for backup data corresponding to the same date, the TV 100 may classify the backup data based on the category. In this regard, the category may indicate whether the backup data is a photo file, a video file, a music file, a healthcare file, or other files. In addition, the TV 100 may output file names of the backup data classified based on the category.

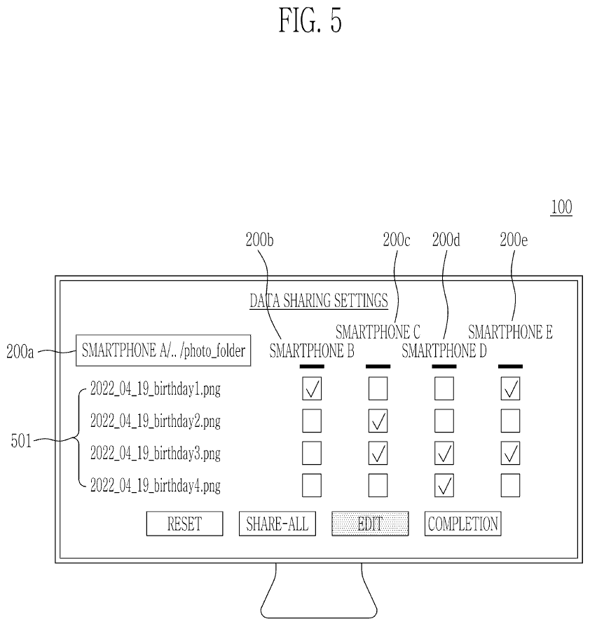

FIG. 5 is a view illustrating an embodiment of sharing data stored in a TV according to an embodiment of the present disclosure. Hereinafter, descriptions that are redundant with the above-described content will be omitted.

In an embodiment of the present disclosure, a scheme for more easily sharing and integrating the data of the respective users in the method for storing and managing the backup data of the family members or the user with the multiple smartphones is to be provided.

In an embodiment of the present disclosure, the TV 100 may set or modify whether to share for each smartphone registered in each data to share the stored smartphone's backup data or the backup data between the family members.

In an embodiment of the present disclosure, the TV 100 may output a backup data list 501 of the smartphone A 200a, and when receiving sharing requests for backup data included in the backup data list 501 from other smartphones 200b, 200c, 200d, and 200e, may transmit the backup data to other smartphones.

More specifically, referring to FIG. 5, the TV 100 may output the backup data list 501 for the backup data of the smartphone A 200a according to the above-described embodiment. For example, the backup data list 501 may include photo files listed with file names.

In an embodiment of the present disclosure, the TV 100 may receive a sharing request for at least one file from the backup data list 501. More specifically, the TV 100 may place the at least one file from the backup data list 501 in each row, and place the at least one smartphone 200b, 200c, 200d, and 200e identified by the TV 100 in each column. Thereafter, the TV 100 may output check boxes that may be clicked for the identified at least one smartphone 200b, 200c, 200d, and 200e for the at least one file. Thereafter, the TV 100 may receive a control signal to click or unclick the check box from the user. In this regard, the user may select the check box using the remote control device (not shown) to click or unclick the check box.

Thereafter, the TV 100 may share the selected backup data file with the selected smartphone based on the user's control signal. Referring to the embodiment in FIG. 5, the TV 100 may transmit a “2022_04_19_birthday1” photo file to the smartphone B 200b and the smartphone E 200e. Similarly, the TV 100 may transmit a “2022_04_19_birthday2” photo file to the smartphone C 200c.

The TV 100 may select or deselect the backup data file to be shared with the smartphones 200b, 200c, 200d, and 200e based on the user's control signal. In addition, the TV 100 may output a reset button, a share-all button, an edit button, and a completion button to facilitate the sharing of the files. Here, the reset button may represent a button to unclick all of the check boxes, the share-all button may represent a button to click all of the check boxes, and the edit button may represent a button to edit an initial check box. Thereafter, when the user presses the completion button, the sharing of the file to each smartphone begins.

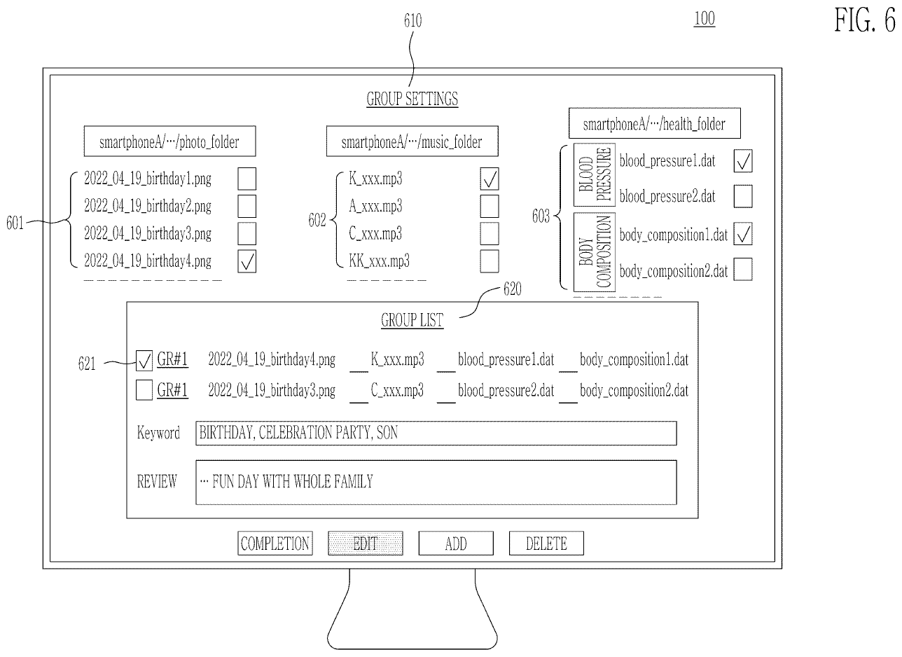

FIG. 6 is a view illustrating an embodiment of managing data stored in a TV according to an embodiment of the present disclosure. Hereinafter, descriptions that are redundant with the above-described content will be omitted.

In an embodiment of the present disclosure, the TV 100 may output a group settings screen 610. Here, the group settings screen 610 may be output after receiving the backup data from the smartphone. Alternatively, the group settings screen 610 may be entered via a settings screen of the TV 100.

Thereafter, the TV 100 may receive a selection corresponding to at least one file of the received backup data included in the group settings screen 610. Accordingly, the TV 100 may create the at least one selected file as a group.

Referring to FIG. 6, the TV 100 may output the backup data included in the group settings screen 610 in the directory structures as in FIG. 4 or in folder structures as in FIG. 6. That is, in the embodiment in FIG. 6, the TV 100 may output the backup data received from the smartphone A in the folder structures. Accordingly, the TV 100 may output a photo file list 601 included in a photo folder, a music file list 602 included in a music folder, and a health file list 603 included in a health folder, from the backup data received from the smartphone A.

In an embodiment of the present disclosure, the TV 100 may receive a selection corresponding to at least some files from the photo file list 601, the music file list 602, and the health file list 603. For example, the TV 100 may receive a signal in which the user selects check boxes corresponding to the at least some files from the remote control device (not shown).

Accordingly, the TV 100 may create a first group 621 composed of the at least some selected files. To this end, the TV 100 may output a group list screen 620. The group list screen 620 may include a description of the group created according to the embodiment described above.

For example, when the user selects a “2022_04_19_birthday4” file from the photo file list 601, selects a “K_xxx” file from the music file list 602, selects a “blood_pressure1” file from the health file list 603, and selects a “body_composition1” file, the TV 100 may create the first group 621 composed of the selected files. Thereafter, the TV 100 may output the files included in the created first group 621 on the group list screen 620.

In addition, in an embodiment, the TV 100 may receive a keyword and a review for the created group from the user. Accordingly, the TV 100 may map the input keyword and review with the created group and store them together.

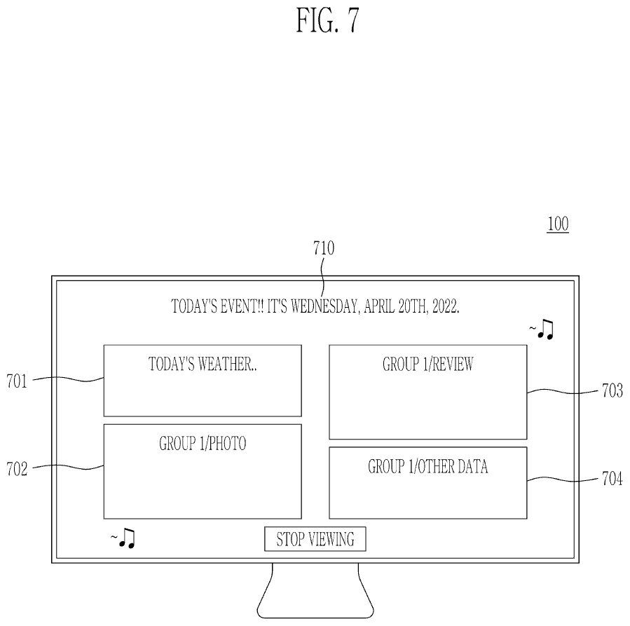

FIG. 7 is a view illustrating a notification service of a TV according to an embodiment of the present disclosure. Hereinafter, descriptions that are redundant with the above-described content will be omitted.

In an embodiment of the present disclosure, the user may register family events, anniversaries, and the like as events. When a scheduled date of the registered event arrives, the TV 100 may compare a subject of the event with a keyword content of the stored group data and output a matching group via a notification service screen 710.

In this regard, the TV 100 may use an always-on function provided by the TV 100 or a separate notification pop-up window. In addition, the TV 100 may output the above-described notification service screen 710 at a preset time, when the TV operation is powered on or off, or when switching the channels.

In an embodiment, the TV 100 may play music when there is a music file in the group, and output a photo when there is a photo file. In addition, the TV 100 may output a review together when the review was input at the time of creating the group. In addition, the TV 100 may output information on today's weather.

In addition, the TV 100 may output a stop viewing button together, and may end the output of the notification service screen 710 based on a control signal of selecting the stop viewing button.

A specific embodiment of the notification service screen 710 will be described with FIG. 7. The TV 100 may receive an event from the user that April 20th is a user's birthday. Thereafter, the TV 100 may output weather information 701 for April 20th when a today's date is April 20th. In addition, when April 20th is the user's birthday, the TV 100 may output a matching group via the notification service screen 710, via comparison with the keyword content of the stored group data according to the embodiment described above. For example, a first group may include a “user's birthday” as the keyword. Accordingly, the TV 100 may output a photo 702 included in the first group, a review 703 of the first group, and other data 704 of the first group on the notification service screen 710.

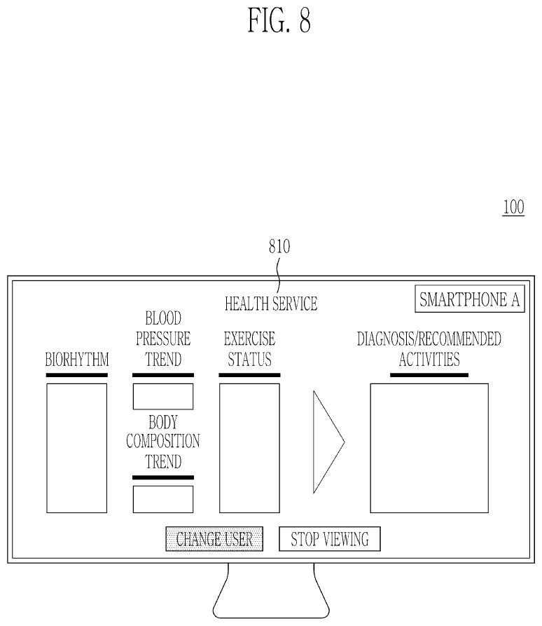

FIG. 8 is a view illustrating a health service of a TV according to an embodiment of the present disclosure. Hereinafter, descriptions that are redundant with the above-described content will be omitted.

With the above-described embodiment, the data of the users' smartphones may be backed up to an internal storage or an external storage of the TV. In this regard, the stored data may be shared with each other or the data may be output via the display or the audio output unit of the TV 100, and convenience may be provided to the users via the notification service screen.

In the embodiment in FIG. 8, an embodiment of outputting a health service screen 810 similar to the notification service screen will be described.

Referring to FIG. 8, the TV 100 may determine trends of the blood pressure, the body composition, and the like based on registered user information (e.g., date of birth, biorhythm, fortune, and the like) and health data of the smartphone transmitted from the user's smartphone to the TV 100. Likewise, the TV 100 may estimate a current health status and introduce recommended activities for health based on the registered user information and the health data of the smartphone transmitted from the user's smartphone to the TV 100. To this end, it may be assumed that the user registers user's account information on the TV 100. In this regard, the account information may include a name, the date of birth, and the like of the user.

In an embodiment, the TV 100 may determine biorhythm, blood pressure trend, body composition trend, exercise status, and diagnosis and recommended activity information output on the health service screen 810 via the controller based on the user information and the smartphone data information of the user, and output them. For example, the TV 100 may determine whether the user has high blood pressure based on the blood pressure and the exercise status included in the health data received from the user's smartphone.

On the other hand, in another embodiment, to output the biorhythm, the blood pressure trend, the body composition trend, the exercise status, and the diagnosis and recommended activity information, which are to be output on the health service screen 810, the TV 100 may transmit the user information and the user's smartphone data information to an external server, and then receive results for the output.

In addition, the TV 100 may output another user's health service screen 810 via a change user button, and may end the output of the health service screen 810 via the stop viewing button and output an existing service of the TV 100.

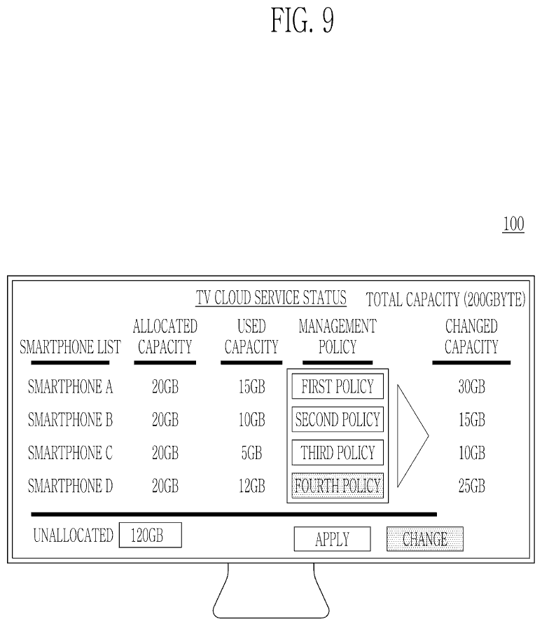

FIG. 9 is a view illustrating a capacity management policy of a TV according to an embodiment of the present disclosure. Hereinafter, descriptions that are redundant with the above-described content will be omitted.

When the data of the multiple smartphones are to be stored and managed on the TV 100, there may be a capacity limitation. Accordingly, the present disclosure is to provide reasonable competition and allocation policies for a limited storage space to the respective users, so that inconvenience of the respective users resulted from the space limitation may be minimized and the data may be managed more conveniently and safely.

Referring to FIG. 9, the TV 100 may set an allocatable capacity for each smartphone of a total capacity (e.g., 200 GByte) that may be provided with the cloud service for the smartphone, and apply a policy for the corresponding capacity to each smartphone. Thereafter, the TV 100 may change the policy via a change button, and apply an allocated capacity based on the changed policy to each smartphone via an apply button.

In this regard, a first policy is a policy that allocates additional capacity to a smartphone with high usage capacity first, a second policy is a policy that allocates allocatable capacity equally to all of the smartphones, a third policy is a policy that manually specifies capacity because of capacity issues or other issues, and a fourth policy is a policy that randomly determines smartphone priorities and allocates capacity based on the priorities.

Referring to the embodiment in FIG. 9, the TV 100 may initially allocate capacity of 20 GB equally to the smartphone A, the smartphone B, the smartphone C, and the smartphone D. Thereafter, the TV 100 may output that the smartphone A has used 15 GByte, the smartphone B has used 10 GByte, the smartphone C has used 5 GByte, and the smartphone D has used 12 GByte.

In an embodiment, when the user selects a change policy button and selects the fourth policy, as the fourth policy is the policy that randomly determines the smartphone priorities and allocates the capacity based on the priorities, the TV 100 may output that 30 GByte will be allocated to the smartphone A, 15 GByte will be allocated to the smartphone B, 10 GByte will be allocated to the smartphone C, and 25 GByte will be allocated to the smartphone D. Thereafter, when the user selects the apply button, the TV 100 may change the capacity policies of the smartphone A, the smartphone B, the smartphone C, and the smartphone D based on the changed fourth policy.

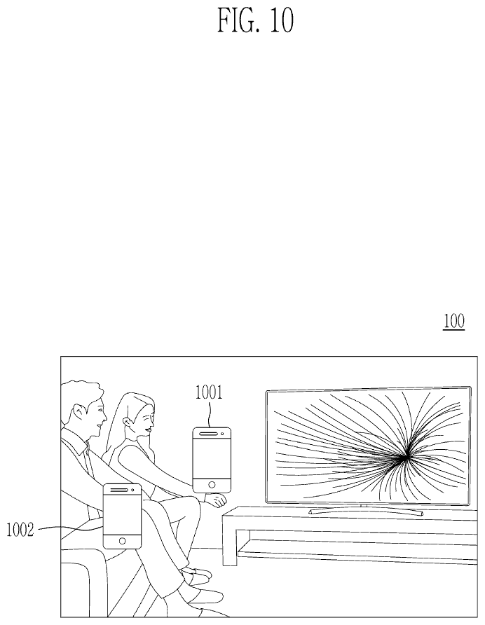

FIG. 10 is a view illustrating an embodiment of exchanging data between users watching a TV according to an embodiment of the present disclosure. Hereinafter, descriptions that are redundant with the above-described content will be omitted.

Referring to FIG. 10, the TV 100 may be in a state of being connected to a smartphone A 1001 and a smartphone B 1002. The TV 100 may receive backup data from the smartphone A 1001 and the smartphone B 1002 based on the backup settings described above.

In an embodiment, the TV 100 may identify that a user A of the smartphone A 1001 and a user B of the smartphone B 1002 are watching the TV 100. To this end, the TV 100 may utilize a front camera, a microphone, a microphone included in the remote control device, and the like. In addition, the TV 100 may determine whether the user A and the user B are watching the TV 100 based on activation states and distances of the connected smartphone A 1001 and smartphone B 1002.

In an embodiment, when the TV 100 determines that the user A and the user B are watching the TV 100, backup data A received from the smartphone A 1001 of the user A and backup data B received from the smartphone B 1002 of the user B may be exchanged.

More specifically, the TV 100 may transmit at least one file of the backup data A that the user A has permitted to be shared with another smartphone to the smartphone B 1002. Similarly, the TV 100 may transmit at least one file of the backup data B that the user B has permitted to be shared with another smartphone to the smartphone A 1001.

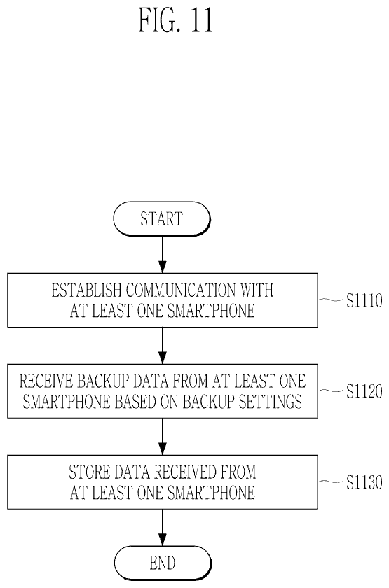

FIG. 11 is a view illustrating a method for controlling a TV according to an embodiment of the present disclosure. Hereinafter, descriptions that are redundant with the above-described content will be omitted.

Referring to FIG. 11, in step (S1110), the TV may be in communication with the at least one smartphone.

In step (S1120), the TV may receive the backup data from the at least one smartphone based on the backup settings. In this regard, the backup settings may include whether to store, the storage start setting, and the storage timing setting. In addition, the TV may receive the backup data in at least one of following situations: at a second time, during the power-on of the TV, during the power-off of the TV, during the execution of the first application, and during the channel switching.

In step (S1130), the TV may store the data received from the at least one smartphone.

In an embodiment, the TV may classify the received backup data into the directory structures based on the owner, the date, and the category of the backup data, and output the classified directory structures via the display.

In an embodiment, the TV may output a backup data list of a first smartphone, and when receiving a request for sharing first backup data included in the list to a second smartphone, transmit the first backup data to the second smartphone.

In an embodiment, the TV may output the group settings screen, receive the selection corresponding to the at least some files of the received backup data included in the group settings screen, and create the group composed of the at least one file based on the selection.

In an embodiment, the TV may receive the event including the date from the user, and output the at least some files included in the created group based on the date of the event via the display. In this regard, the TV may output the at least some files in at least one of the following situations: at the first time, during the power-on of the TV, during the power-off of the TV, and during the channel switching.

In an embodiment, the TV may receive the account information from the user, and output the health service screen via the display based on the account information and the health data received from the user's smartphone.

In an embodiment, the TV may allocate the backup capacity to the at least one smartphone, but the allocated backup capacity may be determined based on the capacity policy selected by the user.

In an embodiment, the TV may identify that a user of a third smartphone and a user of a fourth smartphone are watching the TV, may transmit backup data received from the third smartphone to the fourth smartphone, and transmit backup data received from the fourth smartphone to the third smartphone.

The present disclosure may be implemented as code that can be written to a computer-readable recording medium and can thus be read by a computer. The computer-readable recording medium may be any type of recording device in which data can be stored in a computer-readable manner. Examples of the computer-readable recording medium include a hard disk drive (HDD), a solid state drive (SSD), a silicon disk drive (SDD), a ROM, a RAM, a CD-ROM, a magnetic tape, a floppy disk, optical data storage, and a carrier wave (e.g., data transmission over the Internet). In addition, the computer may include the controller. The above exemplary embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### Industrial Applicability

The present disclosure relates to a TV and a method for controlling the TV, and has industrial applicability as they may be repeatedly implemented.

1. A TV comprising:
a network interface configured to receive data from at least one smartphone;
a display configured to output content;
storage configured to store the data received from the at least one smartphone; and
a controller configured to control the network interface, the display, and the storage,
wherein the controller is configured to:
establish communication with the at least one smartphone; and
receive backup data from the at least one smartphone based on backup settings.

2. The TV of claim 1, wherein the backup settings include whether to store, a storage start setting, and a storage timing setting.

3. The TV of claim 1, wherein the controller is configured to:
classify the received backup data into directory structures based on an owner, a date, and a category of the backup data; and
output the classified directory structures via the display.

4. The TV of claim 1, wherein the controller is configured to:
output a backup data list of a first smartphone; and
when receiving a request for sharing first backup data included in the list to a second smartphone, transmit the first backup data to the second smartphone.

5. The TV of claim 1, wherein the controller is configured to:
output a group settings screen;
receive a selection corresponding to at least some files of the received backup data included in the group settings screen; and
create a group composed of the at least one file based on the selection.

6. The TV of claim 5, wherein the controller is configured to:
receive an event including a date from a user; and
output the at least some files included in the crated group based on the date of the event via the display.

7. The TV of claim 6, wherein the controller is configured to output the at least some files in at least one of following situations: at a first time, during power-on of the TV, during power-off of the TV, and during channel switching.

8. The TV of claim 1, wherein the controller is configured to:
receive account information from a user; and
output a health service screen via the display based on the account information and health data received from a smartphone of the user.

9. The TV of claim 1, wherein the controller is configured to allocate backup capacity to the at least one smartphone, wherein the allocated backup capacity is determined based on a capacity policy selected by a user.

10. The TV of claim 1, wherein the controller is configured to:
identify that a user of a third smartphone and a user of a fourth smartphone are watching the TV;
transmit backup data received from the third smartphone to the fourth smartphone; and
transmit backup data received from the fourth smartphone to the third smartphone.

11. The TV of claim 1, wherein the controller is configured to receive the backup data in at least one of following situations: at a second time, during power-on of the TV, during power-off of the TV, during execution of a first application, and during channel switching.

12. A method for controlling a TV, the method comprising:
establishing communication with at least one smartphone;
receiving backup data from the at least one smartphone based on backup settings; and
storing the data received from the at least one smartphone.
